(19) United States
(12) Patent Application Publication
(10) Pub. No.: US 2026/0365063 A1
(43) Pub. Date: Nov. 19, 2026

(54) SYSTEM AND METHOD FOR CHARGING BATTERY OF VEHICLE, AND VEHICLE COMPRISING THE SAME

(71) Applicants: HYUNDAI MOTOR COMPANY, SEOUL (KR); KIA CORPORATION, SEOUL (KR)

(72) Inventors: Yoo Hong Jang, Hwaseong-si (KR); Ji Eun Hwang, Hwaseong-si (KR); Sang Do Park, Hwaseong-si (KR); Ju Seok Kim, Hwaseong-si (KR); Sang Jin Lee, Hwaseong-si (KR)

(73) Assignees: HYUNDAI MOTOR COMPANY, SEOUL (KR); KIA CORPORATION, SEOUL (KR)

(21) Appl. No.: 19/397,443

(22) Filed: Nov. 21, 2025

(30) Foreign Application Priority Data
May 19, 2025 (KR) 10-2025-0064798

(51) Int. Cl. B60L 53/62; B60L 50/60; H01M 10/44; H01M 10/613; H01M 10/625; H01M 10/6568

(52) U.S. Cl. CPC B60L 53/62; B60L 50/60; H01M 10/443; H01M 10/613; H01M 10/625; H01M 10/6568

(57) ABSTRACT

A battery charging system for a vehicle is disclosed. The battery charging system comprises a coolant-based battery temperature control device, a battery disposed on a flow path of the coolant, a first temperature sensor configured to measure a temperature of the battery and a cell temperature of the battery, and a battery charging device. The battery charging device is configured to determine whether temperature control for the battery is necessary before charging the battery based on a battery cell temperature deviation determined based on the battery cell-specific temperature measured by the first temperature sensor, and to drive the battery temperature control device to circulate the coolant when temperature control for the battery is necessary, thereby reducing cell-to-cell degradation variation while charging the battery.

### CROSS REFERENCE TO RELATED APPLICATIONS

The application claims priority from Korean Patent Application No. 10-2025-0064798 filed on May 19, 2025 in the Korean Intellectual Property Office, the disclosure of which is incorporated herein by reference in its entirety.

### BACKGROUND

### 1. Field

The present disclosure relates to battery charging technology, and more particularly to a battery charging system and method for a vehicle configured to charge a battery while reducing cell-to-cell degradation variation, and a vehicle comprising the same.

### 2. Description of the Related Art

Eco-friendly vehicles such as Hybrid Electric Vehicles (HEV), Plug-in Hybrid Electric Vehicles (PHEV), Electric Vehicles (EV), and Fuel Cell Electric Vehicles (FCEV) are equipped with high voltage battery systems.

When charging and discharging a battery, degradation occurs in the battery. When temperature deviation between cells is large, degradation of cells occurs non-uniformly during charging. The performance of a battery system deteriorates based on the most degraded cell.

Therefore, for optimal battery system performance, all cells should degrade uniformly.

However, when there is a large temperature deviation between battery cells, charging results in non-uniform degradation of the cells. This causes the battery system performance to deteriorate based on the most degraded cell, thereby reducing overall battery performance and shortening battery life.

The above matters disclosed in this section are merely for enhancement of understanding of the general background of the disclosure and should not be taken as an acknowledgement or any form of suggestion that the matters form the related art already known to a person skilled in the art.

### SUMMARY

Therefore, the present disclosure has been made in view of the above problems, and it is an object of the present disclosure to provide a battery charging device and method for a vehicle configured to charge a battery while reducing cell-to-cell degradation variation, and a vehicle comprising the same.

It is another object of the present disclosure to provide a battery charging device and method for a vehicle configured to charge a battery after reducing battery cell temperature deviation using a battery temperature control device when the temperature deviation of battery cells exceeds a reference value, and a vehicle comprising the same.

It is yet another object of the present disclosure to provide a battery charging device and method for a vehicle configured to charge a battery based on a charging current corresponding to battery cell temperature deviation, and a vehicle comprising the same.

Objects are not limited to the above-mentioned objects, and other objects not mentioned herein will be clearly understood by those skilled in the art to which the present disclosure pertains from the following description.

The above and other objects can be accomplished by the provision of a battery charging system for a vehicle according to an embodiment of the present disclosure, comprising: a coolant-based battery temperature control device; a battery disposed on a flow path of the coolant; a first temperature sensor configured to measure a temperature of the battery and a cell-specific temperature of the battery; and a battery charging device configured to determine whether temperature control for the battery is necessary before charging the battery based on a battery cell temperature deviation determined based on the battery cell-specific temperature measured by the first temperature sensor, and to drive the battery temperature control device to circulate the coolant when temperature control for the battery is necessary.

According to an embodiment of the present disclosure, the battery temperature control device may comprise a coolant circulation device and a coolant temperature control device, and the battery charging device may be configured to circulate the coolant by driving only the coolant circulation device.

According to an embodiment of the present disclosure, the battery temperature control device may comprise a coolant circulation line through which the coolant moves, and the battery, the circulation device, and the coolant temperature control device may be disposed on the coolant circulation line, and the coolant may pass through the battery, the circulation device, and the coolant temperature control device.

According to an embodiment of the present disclosure, the battery charging device may be configured to determine that temperature control for the battery is necessary when there is a battery cell having a temperature deviation exceeding a predetermined reference value.

According to an embodiment of the present disclosure, the battery charging device may be configured to charge the battery after driving the battery temperature control device.

According to an embodiment of the present disclosure, the battery charging device may be configured to charge the battery based on a charging current lower than a charging current determined based on a State of Charge (SOC) of the battery and a battery temperature at an initial stage of charging.

According to an embodiment of the present disclosure, the battery charging device may be configured to determine the battery cell temperature deviation based on the battery cell-specific temperature while charging the battery, and to charge the battery based on a charging current corresponding to the determined temperature deviation.

According to an embodiment of the present disclosure, the battery charging device may be configured to charge the battery by increasing the charging current in response to a decrease in the temperature deviation.

According to an embodiment of the present disclosure, the battery charging device may be configured to determine a charging current based on a State of Charge (SOC) of the battery and a battery temperature measured by the first temperature sensor, and to charge the battery based on a charging current determined by applying a weighting factor corresponding to the temperature deviation to the determined charging current.

According to an embodiment of the present disclosure, the battery temperature control device may comprise a second temperature sensor configured to measure a temperature of the coolant, and the battery charging device may be configured to control the battery temperature control device based on the battery cell-specific temperature measured by the first temperature sensor and the coolant temperature measured by the second temperature sensor.

According to an embodiment of the present disclosure, the battery charging device may be configured to determine a maximum temperature and a minimum temperature based on the battery cell-specific temperature measured by the first temperature sensor, and to control a coolant temperature control device of the battery temperature control device such that the coolant temperature measured by the second temperature sensor has an average value of the maximum temperature and the minimum temperature.

According to an embodiment of the present disclosure, the coolant temperature control device may comprise a cooling device configured to cool the coolant, and the battery charging device may be configured to operate the cooling device when the coolant temperature is greater than the average value.

According to an embodiment of the present disclosure, the coolant temperature control device may comprise a heating device configured to heat the coolant, and the battery charging device may be configured to operate the heating device when the coolant temperature is smaller than the average value.

According to an embodiment of the present disclosure, the battery charging device may be configured to charge the battery based on a charging current determined based on a State of Charge (SOC) of the battery and a battery temperature measured by the first temperature sensor when temperature control for the battery is not necessary.

According to an embodiment of the present disclosure, the battery charging device may comprise: a charging circuit configured to output power to be supplied to the battery based on input power; a memory configured to store a predetermined battery charging algorithm; and a processor configured to control the charging circuit based on the predetermined battery charging algorithm.

According to an embodiment of the present disclosure, there is provided a method for charging a battery of a vehicle, the method being performed by a device configured to charge the battery of the vehicle, the method comprising: determining, by the device, a battery cell temperature deviation based on battery cell-specific temperature measured by a first temperature sensor; determining, by the device, whether temperature control for the battery is necessary before charging the battery based on the battery cell temperature deviation; and driving, by the device, a battery temperature control device to circulate the coolant when temperature control for the battery is necessary.

According to an embodiment of the present disclosure, there is provided a vehicle comprising a battery charging system, wherein the battery charging system comprises: a coolant-based battery temperature control device; a battery disposed on a flow path of the coolant; a first temperature sensor configured to measure a temperature of the battery and a cell temperature of the battery; and a battery charging device configured to determine whether temperature control for the battery is necessary before charging the battery based on a battery cell temperature deviation determined based on the battery cell-specific temperature measured by the first temperature sensor, and to drive the battery temperature control device to circulate the coolant when temperature control for the battery is necessary. Specific details according to various embodiments of the present disclosure other than the above-mentioned means for solving the problems are included in the detailed description and drawings below.

According to an embodiment of the present disclosure, it is possible to reduce degradation non-uniformity due to temperature deviation because the battery is charged after reducing battery cell temperature deviation using a battery temperature control device when the temperature deviation of battery cells exceeds a reference value.

In addition, because the battery is charged based on a charging current corresponding to battery cell temperature deviation, the battery can be charged adaptively to temperature, and the time required for charging completion can be minimized while reducing battery performance degradation due to temperature.

Therefore, by using the battery charging technology according to an embodiment of the present disclosure, it is possible to charge the battery while reducing cell-to-cell degradation variation.

Effects obtainable from the present disclosure are not limited to the above-mentioned effects, and other effects not mentioned herein will be clearly understood by those skilled in the art to which the present disclosure pertains from the following description.

### BRIEF DESCRIPTION OF THE FIGURES

The above and other objects, features and other advantages of the present disclosure will be more clearly understood from the following detailed description taken in conjunction with the accompanying drawings, in which:

FIG. 1 is a schematic view showing a configuration of a vehicle 1 according to an embodiment of the present disclosure;

FIG. 2 is a schematic view showing a configuration of a battery charging device 400 according to an embodiment of the present disclosure; and

FIG. 3 is a flowchart illustrating a method for charging a battery of a vehicle according to an embodiment of the present disclosure.

### DETAILED DESCRIPTION

Hereinafter, embodiments of the present disclosure will be described in detail with reference to the accompanying drawings, and the same or similar elements are designated by the same reference numerals regardless of the numerals in the drawings, and redundant description thereof will be omitted.

In describing the embodiments disclosed in this specification, when it is determined that a detailed description of related known technologies may obscure the gist of the embodiments disclosed in this specification, the detailed description will be omitted. In addition, the accompanying drawings are only for easy understanding of the embodiments disclosed in this specification, and the technical ideas disclosed in this specification are not limited by the accompanying drawings, and should be understood to include all changes, equivalents, or substitutes included in the spirit and technical scope of the present disclosure.

Terms including ordinal numbers such as first and second may be used to describe various components, but the components are not limited by the terms. The terms are used only for the purpose of distinguishing one component from another component.

Singular expressions include plural expressions unless the context clearly indicates otherwise.

In this specification, terms such as "include" or "have" are intended to designate that a feature, number, step, operation, component, part, or a combination thereof described in the specification exists, but it should be understood that the existence or addition possibility of one or more other features, numbers, steps, operations, components, parts, or combinations thereof is not excluded in advance.

The suffixes "module" and "unit" for components used in the following description are given or used interchangeably only in consideration of ease of specification preparation, and do not have distinct meanings or roles by themselves.

When a component is referred to as being "connected to" or "connected to" another component, it should be understood that it may be directly connected to or connected to the other component, but other components may exist in between. On the other hand, when a component is referred to as being "directly connected" or "directly connected" to another component, it should be understood that no other components exist in between.

In addition, units or control units included in names are merely terms widely used in naming control devices (controllers) that control vehicle-specific functions, and do not mean generic function units.

A controller may include a communication device that communicates with other controllers or sensors for control of the function in charge, a memory that stores an operating system, logic commands, input/output information, etc., and one or more processors that perform judgments, calculations, decisions, etc. necessary for controlling the function in charge.

Any number of components or various components among the configurations described in this specification may be included within the disclosure described in this specification. Components may include any combination of the features described in this specification and may be arranged in any configuration among the various configurations described in this specification. Concepts regarding the structure and arrangement of the components of the present disclosure as well as their use and operation may be applied to any number of embodiments in any combination as well as the specific embodiments discussed in this specification. Embodiments including those having various features of various arrangements are described below with reference to the drawings.

Hereinafter, various embodiments disclosed in this specification will be described in detail with reference to the accompanying drawings, and the same or similar components will be assigned the same reference numbers regardless of the drawing symbols, and redundant descriptions thereof will be omitted.

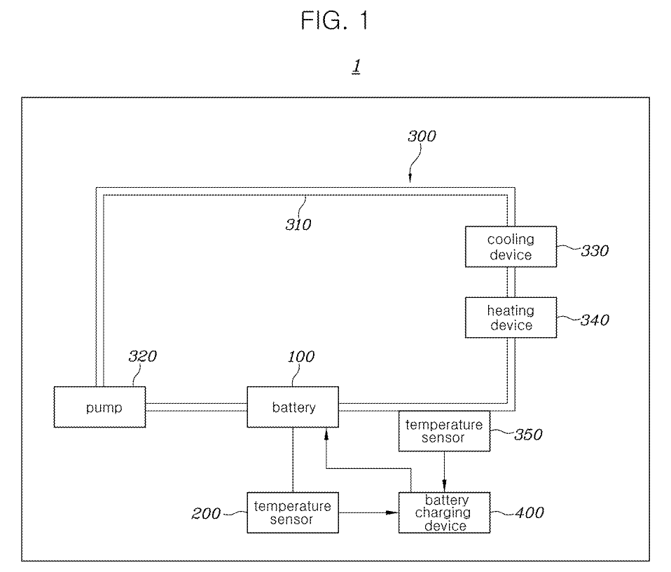

Described in the following embodiments is technology that can reduce cell-to-cell degradation variation while charging the battery.FIG. 1 is a schematic view showing a configuration of a vehicle 1 according to an embodiment of the present disclosure.

Referring to FIG. 1, a battery charging system is mounted in the vehicle 1. The battery charging system may be configured to charge a battery 100 while reducing degradation variation between cells constituting the battery 100 during the charging.

The battery charging system may include a battery 100, a temperature sensor (or first temperature sensor or battery temperature sensor 200, hereinafter, “first temperature sensor”), a battery temperature control device 300, and a battery charging device 400.

The battery 100 may be a battery module implemented in a module form including a plurality of cells, and may be a battery pack implemented in a pack form including a plurality of battery modules.

The battery 100 is configured to accommodate a plurality of cells, and a space through which coolant can flow may be formed inside the battery 100. In addition, the battery 100 may be provided with an inlet configured to allow coolant to flow into the battery 100, and an outlet through which coolant introduced into the battery 100 is discharged.

According to an embodiment, the first temperature sensor 200 may be configured to measure the temperature of the battery 100. In some exemplary embodiments, the first temperature sensor 200 is configured to measure the temperature of each battery cell (hereinafter, “battery cell-specific temperature”).

The battery temperature control device 300 may be configured to control the temperature of the battery 100. For example, the battery temperature control device 300 may operate based on control by the battery charging device 400.

In some example embodiments, the battery temperature control device 300 may be expressed as a temperature control system, a battery cooling device, a battery cooling system, or the like.

According to an embodiment, the battery temperature control device 300 may include a coolant circulation line 310, a pump 320 that is a coolant circulation device, a cooling device 330, a heating device 340, and the like. The configuration of the battery temperature control device 300 is not limited thereto, and other components may be present in various other configurations.

For example, the battery temperature control device 300 may further include a sensor (second temperature sensor or coolant temperature sensor 350) (hereinafter, second temperature sensor) disposed on the coolant circulation line 310 and configured to measure the temperature of the coolant.

As another example, the cooling device 330 and the heating device 340 may be collectively referred to as a coolant temperature control device. For example, the cooling device 330 may be a chiller, and the heating device 340 may be a heater. The types of the cooling device 330 and the heating device 340 are not limited to a heater and a chiller, and other devices may be envisioned.

According to an embodiment, the battery 100, the pump 320, the cooling device 330, and the heating device 340 may be disposed so that coolant can pass through the coolant circulation line 310. Accordingly, the coolant may move along the coolant circulation line 310 and pass through the battery 100, the pump 320, the cooling device 330, and the heating device 340.

The coolant circulation line 310 is a passage through which coolant moves, and first and second ends of the coolant circulation line 310 may be connected to the battery 100. For example, the first end of the coolant circulation line 310 may be connected to an inlet of the battery 100, and the second end of the coolant circulation line 310 may be connected to an outlet of the battery 100.

For example, the coolant may be a gas or a liquid. For example, in the process of passing through the battery 100, the coolant may lower the temperature of some battery cells and raise the temperature of some battery cells, thereby reducing temperature deviation between cells.

The pump 320 may circulate coolant along the coolant circulation line 310. For example, the pump 320 may be an Electric Water Pump (EWP).

According to an embodiment, the pump 320 may operate based on control by the battery charging device 400. For example, the pump 320 may circulate coolant in the coolant circulation line 310 or stop circulation of coolant in the coolant circulation line 310 according to a control signal from the battery charging device 400.

The cooling device 330 may be configured to cool the incoming coolant and discharge it, and the heating device 340 may be configured to heat the incoming coolant and discharge it.

According to an embodiment, the cooling device 330 and the heating device 340 may be controlled by the battery charging device 400.

The battery charging device 400 may control charging of the battery 100. For example, the battery charging device 400 may charge the battery 100 based on power supplied from an external charging device (e.g., Electric Vehicle Supply Equipment (EVSE), and the like).

For example, the battery charging device 400 may charge the battery 100 based on AC power from an external charging device. For example, the battery charging device 400 may charge the battery 100 based on DC power supplied from an external charging device.

In some example embodiments, the battery charging device 400 may perform charging of the battery 100 when a charging plug is connected to a charging inlet installed in the vehicle 1. For example, the battery charging device 400 may perform charging of the battery 100 when a charging plug is connected to a Proximity Pilot (PP) pin of a charging inlet.

The battery charging device 400 may include a battery management device (e.g., Battery Management System (BMS)), an On-Board Charger (OBC), and the like.

For example, the battery charging device 400 may charge the battery 100 based on a SOC (State of Charge)-battery temperature charging current map.

According to an embodiment, when performing charging of the battery 100, the battery charging device 400 may control the battery temperature control device 300 based on battery cell-specific temperature measured by the first temperature sensor 200.

According to an embodiment, when the battery charging device 400 determines that temperature control for the battery 100 is necessary based on the first temperature sensor 220, the battery charging device 400 may drive the battery temperature control device 300.

For example, the battery charging device 400 may determine temperature deviation for battery cells based on temperatures of the battery cells, and may drive the battery temperature control device 300 when there is a case where temperature deviation exceeds a predetermined reference value.

For example, the battery charging device 400 may drive the pump 320 to cause coolant to move along the coolant circulation line 310.

In an embodiment, when conditions for driving the coolant temperature control devices 330 and 340 are not satisfied, the battery charging device 400 may control the temperature of the battery 100 by driving only the pump 320. Since the driving power required for the pump 320 is much lower than the driving power required for the coolant temperature control devices 330 and 340, efficiency of power use can be improved.

According to an embodiment, when the battery charging device 400 drives the battery temperature control device 300 to control the temperature of the battery 100 while charging the battery 100, the charging current may be changed based on temperature deviation.

For example, at an initial stage of charging, the battery charging device 400 may charge the battery 100 based on a charging current lower than a charging current determined based on the SOC (State of Charge) and battery temperature of the battery 100.

For example, when there are many battery cells having temperature deviation exceeding a reference value, the battery charging device 400 may change the charging current based on the temperature deviation having the largest value among temperature deviations exceeding the reference value.

For example, the battery charging device 400 may change the charging current by applying a predetermined weighting factor (α, 0<α<1) for each temperature deviation to a charging current determined based on an SOC-battery temperature charging current map.

According to an embodiment, the weighting factor (α) for each temperature deviation may be set to a higher value as the temperature deviation is lower. That is, the battery charging device 400 may supply the battery 100 by increasing the charging current corresponding to the degree of decrease in temperature deviation.

For example, the battery charging device 400 may apply a weighting factor (α) of 0.3 when the temperature deviation is 10°C or more, apply a weighting factor (α) of 0.6 when the temperature deviation is 8°C or more and less than 10°C, and apply a weighting factor (α) of 0.9 when the temperature deviation is 5°C or more and less than 8°C.

In order to quickly reduce temperature deviation between battery cells, the battery charging device 400 may control the battery temperature control device 300 based on battery cell-specific temperature measured by the first temperature sensor 200 and coolant temperature measured by the second temperature sensor 350.

According to an embodiment, the battery charging device 400 may determine maximum temperature and minimum temperature based on battery cell-specific temperature measured by the first temperature sensor 200, and may control the battery temperature control device 300 so that coolant temperature measured by the second temperature sensor 350 has an average value of the maximum temperature and the minimum temperature.

For example, when coolant temperature measured by the second temperature sensor 350 is greater than an average value of maximum temperature and minimum temperature determined based on battery cell-specific temperature, the battery charging device 400 may operate the cooling device 330 to lower the coolant temperature.

For example, when coolant temperature measured by the second temperature sensor 350 is smaller than an average value of maximum temperature and minimum temperature determined based on battery cell-specific temperature, the battery charging device 400 may operate the heating device 340 to raise the coolant temperature.

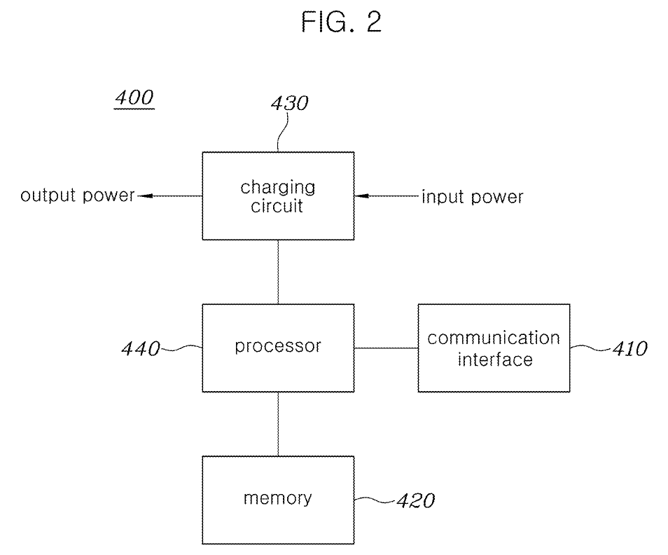

FIG. 2 is a schematic view showing a configuration of a battery charging device 400 according to an embodiment of the present disclosure.

Referring to FIG. 2, the battery charging device 400 may include a communication interface (or communication input/output port) 410, a memory 420, a charging circuit 430, and a processor 440.The configuration of the battery charging device 400 is not limited thereto, and other components may be envisioned as part of the configuration.

The communication interface 410 may receive information necessary for operation of the battery charging device 400 through an in-vehicle network. For example, the in-vehicle network may include Controller Area Network (CAN), Local Interconnect Network (LIN), FlexRay, CAN FD (Flexible Data-rate), Media Oriented Systems Transport (MOST), and the like.

According to an embodiment, the communication interface 410 may include a communication circuit configured to communicate with the first temperature sensor 200, a communication circuit configured to communicate with the second temperature sensor 350, and the like.

The memory 420 may store algorithms (or software or programs or computer-executable instructions), data, etc. necessary for operation of the battery charging device 400. For example, the memory 420 may store algorithms, data, etc. necessary to perform charging control for the battery 100. For example, the memory 420 may store an SOC-battery temperature charging current map.

For example, the memory 420 may be implemented as at least one or more storage media among storage media (or recording media) such as flash memory, hard disk, Secure Digital Card (SD card), Random Access Memory (RAM), Static Random Access Memory (SRAM), Read Only Memory (ROM), Programmable Read Only Memory (PROM), Electrically Erasable and Programmable ROM (EEPROM), Erasable and Programmable ROM (EPROM), registers, removable disks, and web storage.

The charging circuit 430 may output power (output power) for charging the battery 100 based on input power.

For example, the charging circuit 430 may include an On-Board Charger (OBC), and may additionally comprise other components.

According to an embodiment, the charging circuit 430 may change charging current based on control by the processor 440. For example, the charging circuit 430 may charge the battery 100 based on current corresponding to a current command output from the processor 440.

The processor 440 may control overall operation of the battery charging device 400. The processor 440 may control charging of the battery 100 based on signals/data/information received through the communication interface 410, algorithms/data stored in the memory 420, and the like.

To this end, the processor 440 may be a data processing device implemented as hardware having a circuit having a physical structure for executing desired operations. For example, the desired operations may include code or instructions included in a program. For example, a data processing device implemented as hardware may include a microprocessor, a central processing unit, a processor core, a multi-core processor, a multiprocessor, an Application-Specific Integrated Circuit (ASIC), and a Field Programmable Gate Array (FPGA).

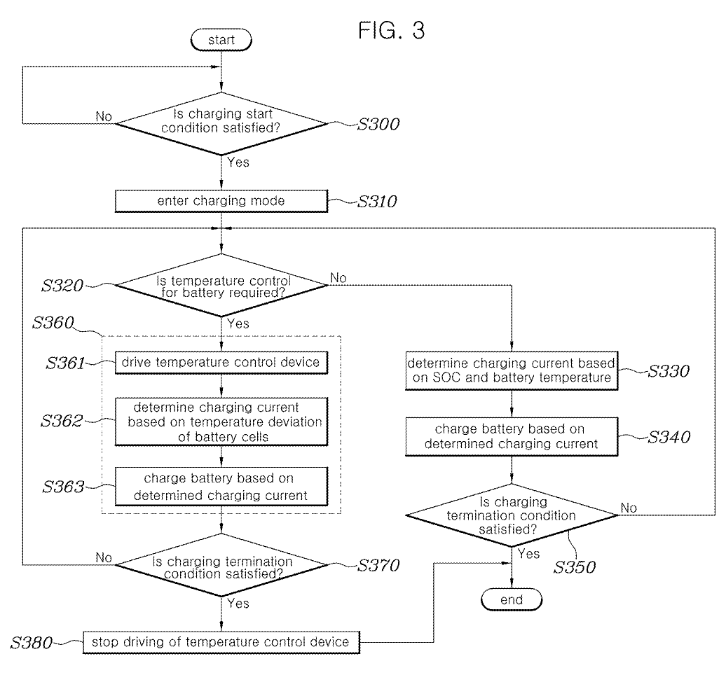

FIG. 3 is a flowchart illustrating a method for charging a battery of a vehicle according to an embodiment of the present disclosure.

Referring to FIG. 3, the battery charging device 400 determines whether a charging start condition for the battery 100 is satisfied in step S300, and when the charging start condition is satisfied (S300-Yes), may enter a charging mode for performing charging of the battery 100 in step S310.

For example, the battery charging device 400 may determine that a charging condition is satisfied when a charging cable is connected to a charging inlet of the vehicle 1, and a method for determining whether a charging condition is satisfied is not limited thereto.

After entering the charging mode, the battery charging device 400 may determine whether temperature control for the battery 100 is necessary in step S320.

According to an embodiment, the battery charging device 400 may determine temperature deviation for battery cells based on battery cell-specific temperature measured by the first temperature sensor 200, and may determine that temperature control for the battery 100 is necessary when there is a case where temperature deviation exceeds a predetermined reference value.

Thereafter, when the battery charging device 400 determines that temperature control for the battery 100 is not necessary (S320-No), that is, when there is no battery cell having temperature deviation exceeding a reference value, the battery charging device 400 may determine charging current based on SOC and battery temperature in step S330, and may charge the battery 100 based on the determined charging current in step S340.

In operation S330, the battery charging device 400 may determine charging current based on a pre-stored SOC-battery temperature charging current map.

Thereafter, the battery charging device 400 may determine whether a charging termination condition is satisfied in step S350.

According to an embodiment, the battery charging device 400 may determine whether the SOC of the battery 100 has reached a predetermined charging completion SOC.

When the charging termination condition is satisfied (S350-Yes), that is, when the SOC of the battery 100 has reached the charging completion SOC, the battery charging device 400 may terminate charging of the battery 100.

When the charging termination condition is not satisfied (S350-No), that is, when the SOC of the battery 100 does not reach the charging completion SOC, the battery charging device 400 may perform operation S320.

Meanwhile, when the battery charging device 400 determines in operation S320 that temperature control for the battery 100 is necessary (S320-Yes), that is, when there is a battery cell having temperature deviation exceeding a reference value, the battery charging device 400 may control the temperature of the battery 100 and charge the battery 100 based on charging current determined based on battery cell temperature deviation in step S360 (S361~S363).

In operation S361, the battery charging device 400 may control the temperature of the battery 100 by driving the pump 320 to cause coolant to flow through the battery 100.

According to an embodiment, the battery charging device 400 may determine maximum temperature and minimum temperature based on battery cell-specific temperature measured by the first temperature sensor 200, and may control the battery temperature control device 300 so that coolant temperature measured by the second temperature sensor 350 has an average value of the maximum temperature and the minimum temperature.

According to an embodiment, when coolant temperature measured by the second temperature sensor 350 is greater than an average value of maximum temperature and minimum temperature determined based on battery cell-specific temperature, the battery charging device 400 may operate the cooling device 330 to lower the coolant temperature.

For example, when coolant temperature measured by the second temperature sensor 350 is smaller than an average value of maximum temperature and minimum temperature determined based on battery cell-specific temperature, the battery charging device 400 may operate the heating device 340 to raise the coolant temperature.

In operation S362, the battery charging device 400 may determine charging current by applying a predetermined weighting factor (α) for each temperature deviation to charging current determined based on an SOC-battery temperature charging current map.

According to an embodiment, the battery charging device 400 may determine charging current to be high corresponding to the degree of decrease in temperature deviation.

In this way, because the battery charging device 400 performs charging of the battery 100 after reducing battery cell temperature deviation using the battery temperature control device 300 when temperature deviation of battery cells exceeds a reference value, degradation non-uniformity due to temperature deviation can be reduced.

In addition, because the battery charging device 400 charges the battery 100 based on charging current corresponding to battery cell temperature deviation, the battery 100 can be charged adaptively to temperature, and the time required for charging completion can be minimized while reducing battery performance degradation due to temperature.

Thereafter, the battery charging device 400 may determine whether a charging termination condition is satisfied in step S370. According to an embodiment, the battery charging device 400 may determine whether the SOC of the battery 100 has reached a predetermined charging completion SOC.

When the charging termination condition is satisfied (S370-Yes), that is, when the SOC of the battery 100 has reached the charging completion SOC, the battery charging device 400 may stop driving of the battery temperature control device 300 in step S380, and may terminate charging of the battery 100.

When the charging termination condition is not satisfied (S370-No), that is, when the SOC of the battery 100 does not reach the charging completion SOC, the battery charging device 400 may perform operation S320.

Although specific embodiments related to the present disclosure have been shown and described, it will be apparent to those skilled in the art that the present disclosure may be variously improved and changed within the scope that does not depart from the technical spirit of the present disclosure provided by the following claims.

1. A battery charging system of a vehicle, comprising:
a coolant-based battery temperature control device;
a battery disposed on a flow path of the coolant;
a first temperature sensor configured to measure a temperature of the battery and a cell-specific temperature of the battery; and
a battery charging device configured to determine whether temperature control for the battery is necessary before charging the battery based on a battery cell temperature deviation determined based on a battery cell-specific temperature measured by the first temperature sensor, and to drive the battery temperature control device to circulate the coolant in response to determining that temperature control for the battery is necessary.

2. The battery charging system of claim 1, wherein the battery temperature control device comprises a coolant circulation device and a coolant temperature control device, and
wherein the battery charging device is configured to circulate the coolant by driving only the coolant circulation device.

3. The battery charging system of claim 2, wherein the battery temperature control device comprises a coolant circulation line through which the coolant moves,
wherein the battery, the coolant circulation device, and the coolant temperature control device are disposed on the coolant circulation line, and
wherein the coolant passes through the battery, the coolant circulation device, and the coolant temperature control device.

4. The battery charging system of claim 1, wherein the battery charging device is configured to determine that temperature control for the battery is necessary based on existence of a battery cell having a temperature deviation exceeding a predetermined reference value.

5. The battery charging system of claim 1, wherein the battery charging device is configured to charge the battery after driving the battery temperature control device.

6. The battery charging system of claim 5, wherein the battery charging device is configured to charge the battery based on a charging current lower than a charging current determined based on a State of Charge (SOC) of the battery and a battery temperature at an initial stage of charging.

7. The battery charging system of claim 5, wherein the battery charging device is configured to determine the battery cell temperature deviation based on the battery cell-specific temperature while charging the battery, and to charge the battery based on a charging current corresponding to the determined temperature deviation.

8. The battery charging system of claim 7, wherein the battery charging device is configured to charge the battery by increasing the charging current in response to a decrease in the temperature deviation.

9. The battery charging system of claim 7, wherein the battery charging device is configured to determine a charging current based on a State of Charge (SOC) of the battery and a battery temperature measured by the first temperature sensor, and to charge the battery based on a charging current determined by applying a weighting factor corresponding to the temperature deviation to the determined charging current.

10. The battery charging system of claim 1, wherein the battery temperature control device comprises a second temperature sensor configured to measure a temperature of the coolant, and
wherein the battery charging device is configured to control the battery temperature control device based on the battery cell-specific temperature measured by the first temperature sensor and the coolant temperature measured by the second temperature sensor.

11. The battery charging system of claim 10, wherein the battery charging device is configured to determine a maximum temperature and a minimum temperature based on the battery cell-specific temperature measured by the first temperature sensor, and to control a coolant temperature control device of the battery temperature control device such that the coolant temperature measured by the second temperature sensor has an average value of the maximum temperature and the minimum temperature.

12. The battery charging system of claim 11, wherein the coolant temperature control device comprises a cooling device configured to cool the coolant, and
wherein the battery charging device is configured to operate the cooling device based on the coolant temperature being greater than the average value.

13. The battery charging system of claim 11, wherein the coolant temperature control device comprises a heating device configured to heat the coolant, and
wherein the battery charging device is configured to operate the heating device based on the coolant temperature being smaller than the average value.

14. The battery charging system of claim 1, wherein the battery charging device is configured to charge the battery based on a charging current determined based on a State of Charge (SOC) of the battery and a battery temperature measured by the first temperature sensor based on temperature control for the battery not being necessary.

15. The battery charging system of claim 1, wherein the battery charging device comprises:
a charging circuit configured to output power to be supplied to the battery based on input power;
a memory configured to store a predetermined battery charging algorithm; and
a processor configured to control the charging circuit based on the predetermined battery charging algorithm.

16. A method for charging a battery of a vehicle, the method being performed by a device configured to charge the battery of the vehicle, the method comprising:
determining, by the device, a battery cell temperature deviation based on a battery cell-specific temperature measured by a first temperature sensor;
determining, by the device, whether temperature control for the battery is necessary before charging the battery based on the battery cell temperature deviation; and
driving, by the device, a battery temperature control device to circulate the coolant in response to determining that temperature control for the battery is necessary.

17. A vehicle comprising a battery charging system, wherein the battery charging system comprises:
a coolant-based battery temperature control device;
a battery disposed on a flow path of the coolant;
a first temperature sensor configured to measure a temperature of the battery and a cell temperature of the battery; and
a battery charging device configured to determine whether temperature control for the battery is necessary before charging the battery based on a battery cell temperature deviation determined based on the battery cell-specific temperature measured by the first temperature sensor, and to drive the battery temperature control device to circulate the coolant in response to determining that temperature control for the battery is necessary.
